(19) United States
(12) Patent Application Publication
(10) Pub. No.: US 2014/0356101 A1
(43) Pub. Date: Dec. 4, 2014

(54) Weld Rivet Joint

(71) Applicant: Daimler AG, Stuttgart (DE)

(72) Inventors: Juergen BASSLER, Achern (DE); Tycho EULENSTEIN, Kassel (DE); Rudolf REINHARDT, Esslingen (DE); Heiko STEINMETZ, Ohmden (DE); Alexander THEIERL, Vaihingen-Ensingen (DE); Bernhard ZIEGLER, Rechberghausen (DE)

(21) Appl. No.: 14/453,134

(22) Filed: Aug. 6, 2014

Related U.S. Application Data
(62) Division of application No. 12/991,008, filed on Jan. 13, 2011, now abandoned.

(30) Foreign Application Priority Data
May 6, 2008 (DE) 10 2008 022 263.1
Jul. 2, 2008 (DE) 10 2008 031 121.9

(51) Int. Cl. F16B 19/06

(52) U.S. Cl. CPC F16B 19/06
USPC 411/506

(57) ABSTRACT

A weld rivet joint between one or more components and a base component is provided. The one or more components have a hole through which a weld rivet having a head projects with its shank. The shank is welded to the surface of the base component by its end face and is plastically deformed. The weld rivet has a shank that is shorter than its head diameter, and in a transition region between head and shank a continuous annular recess is provided for the accommodation of material displaced in the riveting process and/or for tolerance compensation.

### CROSS-REFERENCE TO RELATED APPLICATIONS

This application is divisional of U.S. application Ser. No. 12/991,008, filed Jan. 30, 2009, which is a national stage of PCT International Application No. PCT/EP2009/000595, filed Jan. 30, 2009, and claims priority under 35 U.S.C. §119 to German Patent Application No. 10 2008 022 263.1, filed May 6, 2008 and to German Patent Application No. 10 2008 031 121.9, filed Jul. 2, 2008, the entire disclosure of the afore-mentioned documents is herein expressly incorporated by reference.

### BACKGROUND AND SUMMARY OF THE INVENTION

In a weld rivet joint, two or more components are joined in one operation involving a welded joint and a plastic deformation during a riveting process. By means of a weld rivet joint, it is possible to join one or more components to a base component by their respective end faces without having to provide a hole penetrating the base component.

To produce the weld rivet joint, a weld rivet is inserted through a hole provided in one or more components until its end face, which is in front in the direction of insertion, contacts the base component. Following this, the end face of the weld rivet is welded to the surface of the base component, usually in a resistance welding process. In the next and final process step, the weld rivet is deformed plastically by the application of a second electric pulse following the first welding pulse after a short interval. This welding pulse heats and softens the weld rivet, which is plastically deformed by a force acting in the longitudinal direction of the weld rivet. The plastic deformation results in a compression of the shank of the weld rivet, which is thereby jammed in the hole of the components to be secured. On completion of the process, the weld rivet shrinks owing to the preceding thermal expansion, resulting in an additional clamping effect of the weld rivet joint and thus in a high strength.

German Patent Document DE 10 2005 006 253 B4 discloses a generic weld rivet joint produced in a single operation is known, wherein the welding process and a plastic deformation of the weld rivet immediately follow each other. By providing a head on the weld rivet, it is in particular possible to join non-metallic components to the metallic base component.

The present invention is based on the problem of specifying an alternative but equivalent embodiment for a weld rivet joint.

According to the invention, this problem is solved by the subject matter of the independent claims. Advantageous further developments form the subject of the dependent claims.

The invention is based on the general idea of providing, on a first weld rivet of a weld rivet joint in a transition region between head and shank, a continuous annular recess designed to receive material displaced in the riveting process and/or for tolerance compensation. The weld rivet forms a part of a weld rivet joint according to the invention between one or more components and a base component, the component(s) having a hole through which the weld rivet provided with a head extends with its shank. In this arrangement, the shank of the weld rivet is shorter in comparison to the head diameter and is therefore particularly suitable for joining thin components such as sheet metal parts. The end face of the weld rivet shank contacts a surface of the base component and is welded to the base component in this region in a first operation. The weld rivet is then heated and softened by a second electric pulse and upset by means of a high compressive force, wherein the axial preload of the weld rivet can be influenced directly by a ratio between an axial length of the recess and the overall length of the weld rivet. In this context, for example, a recess located immediately adjacent to the end region provided for welding is advantageous for a tempering effect provided by the subsequent riveting process wherein the weld rivet is heated again by means of a second electric pulse, which has a beneficial effect on the welding process. The depth of the recess can moreover be used to influence the heating temperature of the weld rivet as it is re-heated during the riveting process, and this temperature can in turn influence the deformability of the weld rivet in the region heated in this way.

In another embodiment of the solution according to the invention, the base component has a cavity which accommodates at least the end region and parts of the shank of the weld rivet. This results in a weld rivet joint with a particularly high preload, as the available shrinkage length of the weld rivet can be increased by the section extending into the cavity.

In a further advantageous embodiment of the solution according to the invention, the end face of the weld rivet shank is conical. As the diameter of the weld rivet increases, the planar welding of a full cross-section becomes more difficult, which is due to the inhomogeneous current and force distribution across the cross-section of the weld rivet. By using the conical end face of the weld rivet shank, it is possible to produce a weldable annular projection which, although it is lost in the welding process, allows for an extremely accurately repeatable weld quality. In this context, it is in particular conceivable to separate the welding process from the subsequent riveting process, in particular using different operations and even different machinery, if the material of the base component differs from the material of the components to be joined thereto and if the weld rivet has a larger diameter. It may for example be advantageous to weld the weld rivet by means of capacitor discharge welding, followed by riveting in another station in a conventional resistance welding machine.

In a further alternative embodiment of the solution according to the invention, the weld rivet is designed as a tubular rivet with a blind hole open either towards the end face of the shank or towards the head. In this way, a particularly light-weight weld rivet can be produced with a small amount of heat and reduced riveting force requirements, wherein, if the end face of the shank is annular, the blind hole provides a location for spatter, so that it cannot endanger the quality of the weld rivet joint to be produced by uncontrolled splashing.

Further important features and advantages of the invention can be derived from the dependent claims, the drawings and the description of the figures with reference to the drawings.

It is understood that the features mentioned above and yet to be explained below can be used not only in the specified combination, but also in other combinations or individually, without exceeding the scope of the present invention.

### BRIEF DESCRIPTION OF THE DRAWING FIGURES

Preferred embodiments of the invention are shown in the drawings and explained in greater detail in the following description, identical reference numbers identifying identical, similar or functionally identical components.

Of the diagrammatic figures:

FIGS. 1a and 1b are a side view and a sectional view of a weld rivet according to the invention,

FIG. 2a shows the individual components of a weld rivet joint according to the invention,

FIG. 2b shows a weld rivet joint after the welding process,

FIG. 2c shows a completed weld rivet joint,

FIG. 3a shows another embodiment in a view corresponding to FIG. 2a,

FIG. 3b shows a completed weld rivet joint with the components from FIG. 3a,

FIGS. 4a, b show an exploded view and a completed weld rivet joint with a weld rivet having a countersunk head,

FIGS. 5a, b correspond to FIGS. 4a and b, but show a different embodiment,

FIGS. 6a to 9a are exploded views of a weld rivet joint according to the invention,

FIGS. 6b to 9b show completed weld rivet joints,

FIGS. 10a-10c shows a weld rivet with an integral stud bolt,

FIGS. 11a and 12a show a further embodiment of a weld rivet joint according to the invention with a weld rivet, initially without a head,

FIGS. 11b and 12b show a weld rivet joint made using the components from FIGS. 11a and 12a after the welding process,

FIGS. 11c and 12c show completed weld rivet joints with swaged-on heads,

FIGS. 13a to c show differently shaped end faces of the weld rivet,

FIGS. 14a to d show weld rivets with a polygonal shank or a polygonal head, and

FIGS. 15a to c show a weld rivet joint according to the invention joining a turbine wheel to a shaft.

### DETAILED DESCRIPTION OF THE DRAWING FIGURES

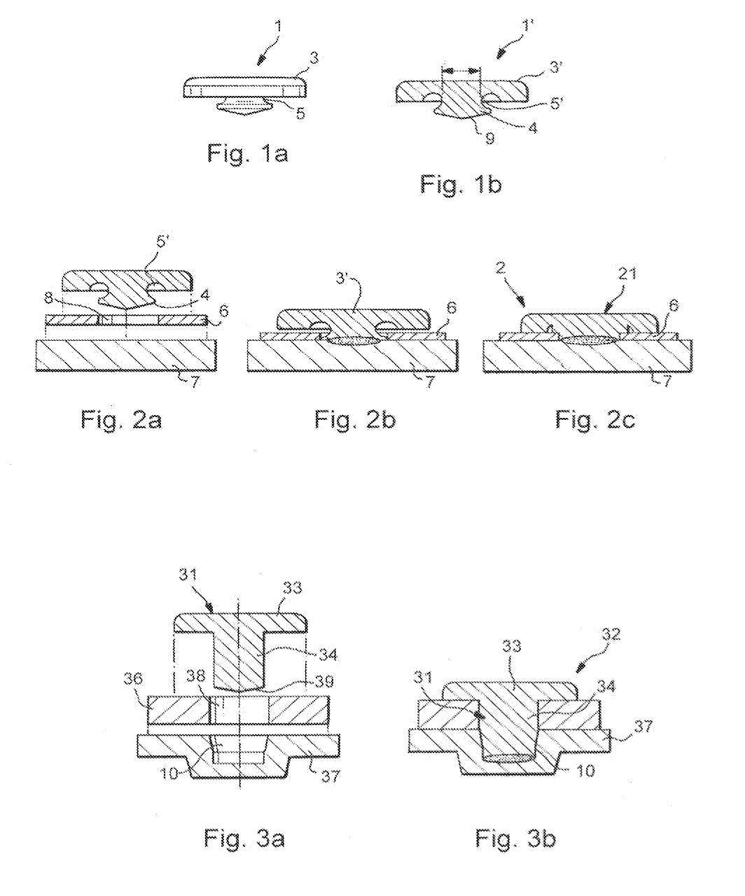

According to FIGS. 1a and 1b, a weld rivet 1, 1′ of a weld rivet joint 2 shown by way of example in FIGS. 2b and 2c comprises a head 3, 3′ and a shank 4. In the region of its shank 4, the weld rivet 1, 1′ has a continuous annular recess 5, 5′ which in the case of the weld rivet 1′ according to FIGS. 1b and 2a-2c continues in the head 3′ for the accommodation of material displaced in the riveting process and/or for tolerance compensation. The weld rivet joint 2 according to the invention is generally used to join one or more components 6 to a base component 7 (cf. FIG. 2a), the component(s) 6 having a hole 8 through which the weld rivet 1 projects with its shank 4. The embodiment shown in FIGS. 1a, 1b, and 2a-2c is designed for joining thin components in particular.

The weld riveting process itself is carried out as follows:

The shank 4 of the weld rivet 1′ is first inserted through the hole 8 of the at least one component 6 to be joined to the base component 7, until its end face 9 contacts the base component 7. A current pulse is then used to heat the end face 9 of the weld rivet 1, welding it to the base component 7 as shown in FIG. 2b by way of example. After this welded joint has been made between the shank 4 and the base component 7, a further current pulse heats the shank 4 of the weld rivet 1, thereby softening it, so that the application of a compressive force to the weld rivet 1 establishes a firm contact between the head 3′ of the latter and the component 6 to be joined. As the weld rivet 1′ subsequently cools, it contracts owing to its preceding thermal expansion, resulting in an extremely firm and stable weld rivet joint 2 by means of which very thin components 6 in particular can be secured to the base component 7. In a weld rivet joint 2 of this type, it is further possible to secure a non-metallic component 6 to the base component 7 using a weld rivet joint 2. Particularly advantageous in all of the illustrated weld rivet joints 2 is the fact that the weld rivet joint 2 can be produced from one side only, so that there is no need for a through-hole in the base component 7, for example to insert a screw or bolt. The welded joint can generally be produced by friction or resistance welding.

The weld rivet joint 2 according to the invention in particular allows components 6 made of very different materials to be joined, such as plastics, fibre-reinforced plastics, magnesium, nickel, chromium-nickel, copper etc. The material of the weld rivet 1 will of course have to be matched to the expected thermal and/or mechanical stresses. The welding operation itself can be performed using conventional welding tongs, permitting the use of existing means of production.

According to FIGS. 3a and 3b, the base component 37 has a cavity 10 which accommodates at least the end region 39 and parts of the shank 34 of the weld rivet 31. This may, for example, be cylindrical like the shank 4 of the weld rivet 1 or at least partially conical as shown in FIG. 3a. With an embodiment of the weld rivet joint 32 according to FIGS. 3a and 3b, a particularly high preload can be obtained, because the shank 34 of the weld rivet 31 can be made longer, so that the thermal shrinkage involved in the cooling of the weld rivet 31 causes a stronger deformation.

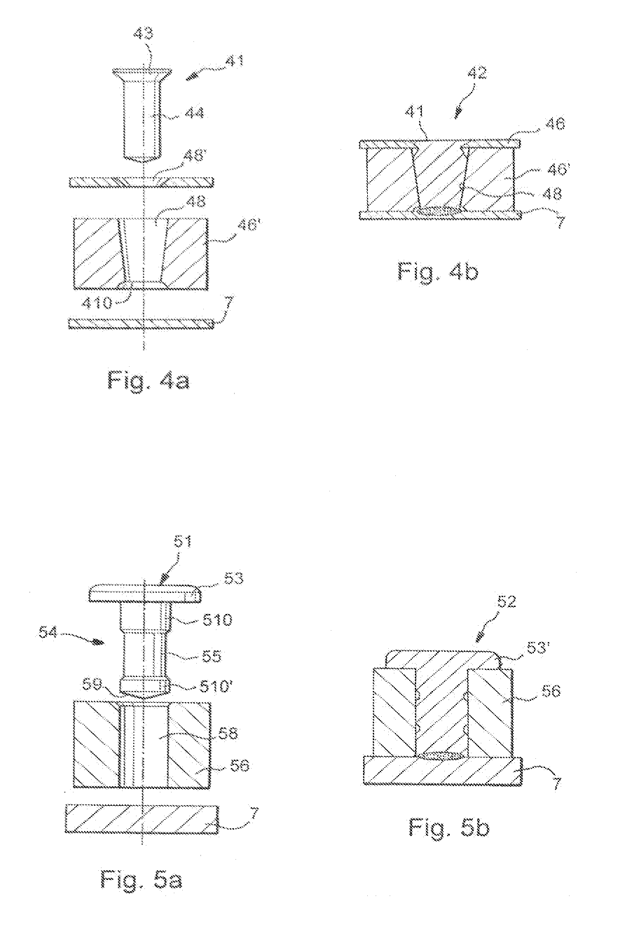

According to FIGS. 4a and 4b, a weld rivet 41 has a cylindrical shank and a head 43 with the shape of a truncated cone which, after the completion of the weld rivet joint 42 as shown by way of example in FIG. 4b, is recessed and therefore flush with a surface of the component 46. The hole 48 of the weld rivet joint 42 shown in FIGS. 4a and 4b is conical in shape and has at the end facing the base component 7 a location space, for example a bead chamber 410 where material produced in the welding process can be accommodated without getting into the space between the component 46 and the base component 7, thereby affecting the quality of the weld rivet joint 42. As a current pulse is applied to the weld rivet 41 in the following riveting process, thereby softening it, it is pushed into the conical hole 48 and preferably deposited on its inner wall. As the weld rivet joint 42 cools, an extremely secure joint is achieved.

As it is not always possible to provide a conical shape for the hole 48, the weld rivet 1 can alternatively be centered as shown in FIGS. 5a and 5b by means of so-called centering sections 510 and 510′, which may be provided axially adjacent to the recess 55. As the weld rivet 1 is riveted as shown in FIG. 5b, it is heated particularly intensively in the region of the recess 55, with the result that this region is deformed particularly strongly. In principle, it is provided that the diameter of the shank 54 defines the nominal diameter of the weld rivet 51 in the region of the recess 55. The axial preload of the weld rivet 51 can be influenced by means of the ratio between the axial length of the recess 55 and the overall length. In addition, it is possible to produce, by using the position of the recess 55, for example close to the weld, an advantageous tempering effect in the subsequent riveting process. The volume will obviously have to be selected while taking into account the tolerance compensation required.

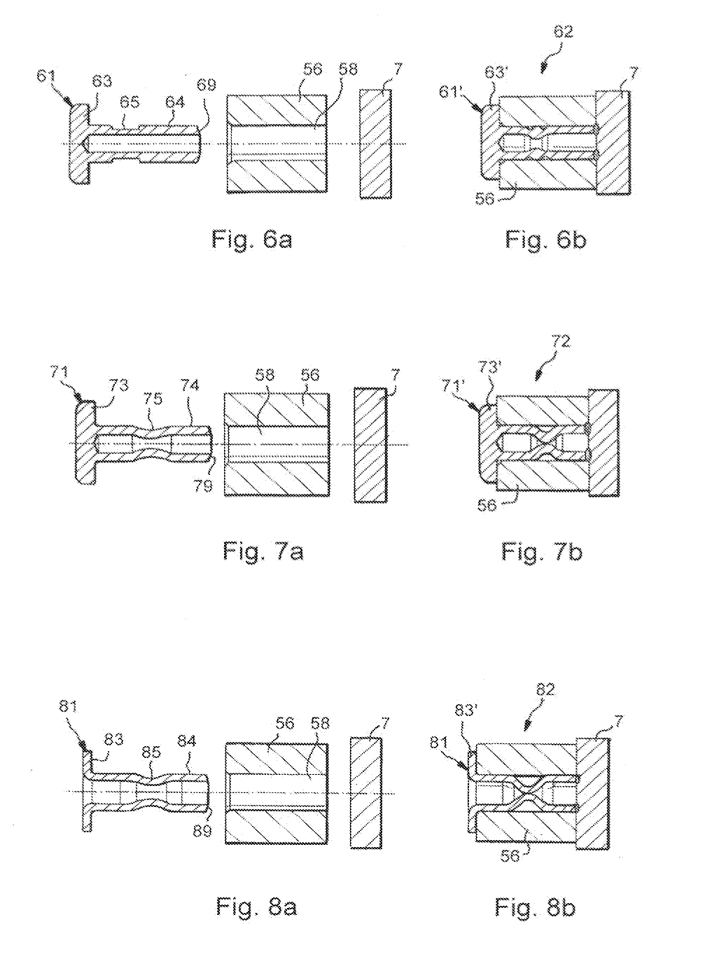

If weld rivet joints are produced using a weld rivet with a large shank diameter, the planar welding of the full cross-section of the end face can be difficult, which is in particular due to the inhomogeneous current and force distribution across the cross-section. For this reason, the end face 69, 79, 89 of the weld rivet 61, 71, 81 is designed conical or that the weld rivet 61, 71, 81 is itself designed as a tubular rivet with an end which is open towards the end face 69, 79, 89 of the shank 64, 74, 84. This end may be designed as a blind hole. Such a tubular rivet is shown by way of example in FIGS. 6 to 8. FIGS. 6b to 8b in particular show that the weld itself between the end face 69, 79, 89 of the shank 64, 74, 84 which is annular in the illustrated embodiment, and the base component 7 is significantly smaller. In all of these variants, the recess 65, 75, 85 can for example be produced by a machining process, in particular turning, or by mechanical pinching. Examples for machining processes are shown in FIGS. 5a and 6a, while pinched recesses 75, 85 are shown in FIGS. 7a and 8a by way of example. In this context, it may be provided that the shank 54, 64, 74, 84 of the weld rivet 51, 61, 71, 81 is designed as a tubular body to the end of which the head 53, 63, 73, 83 is attached. Depending on the design of the recess 65, 75, 85 the deformed weld rivet 61, 71, 81 may have different shapes following the completion of the weld rivet joint 62, 72, 82 as is illustrated in FIGS. 6b to 8b by way of example. The recess 55, 65, 75, 85 may further be produced in an extrusion process.

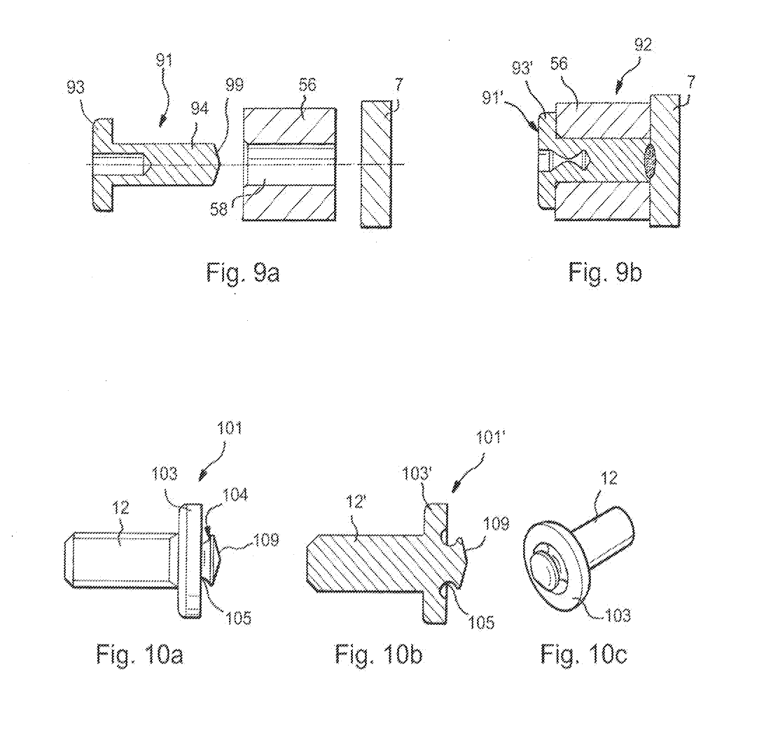

A weld rivet according to FIGS. 9a and 9b likewise has an open end in the form of a blind hole, which is however open towards the head 93, 93′.

FIGS. 10a-10c respectively show a side view, a cross-section and an oblique view of a weld rivet 101, 101′ according to the invention, which is provided with stud bolt 12, 12′ on the side of the head 103, 103′ which is remote from the shank 104, so that further components can be fitted.

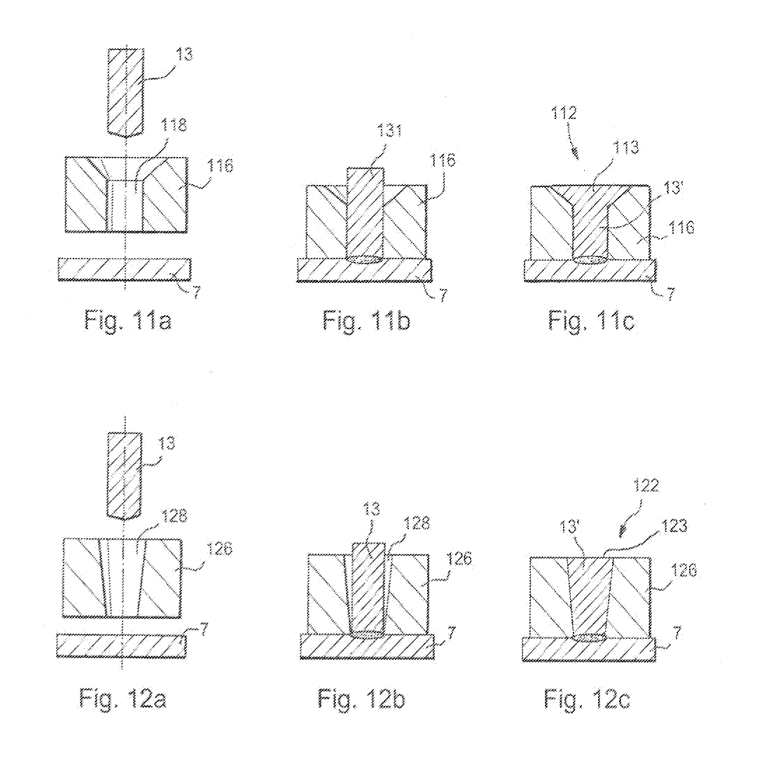

The weld rivet 13, 13′ may, in its original state, be designed without a head 3 as shown by way of example in FIGS. 11a and 12a. In this case, a head 113, 123 stabilising the weld rivet joint 112, 122 is produced during the riveting operation. A head 113, 123 produced in this way is shown in FIG. 11c by way of example. It is of course possible to deform the shank 13′ of the originally headless weld rivet 13, such that a head 123 can be shaped as shown in FIG. 12c by way of example.

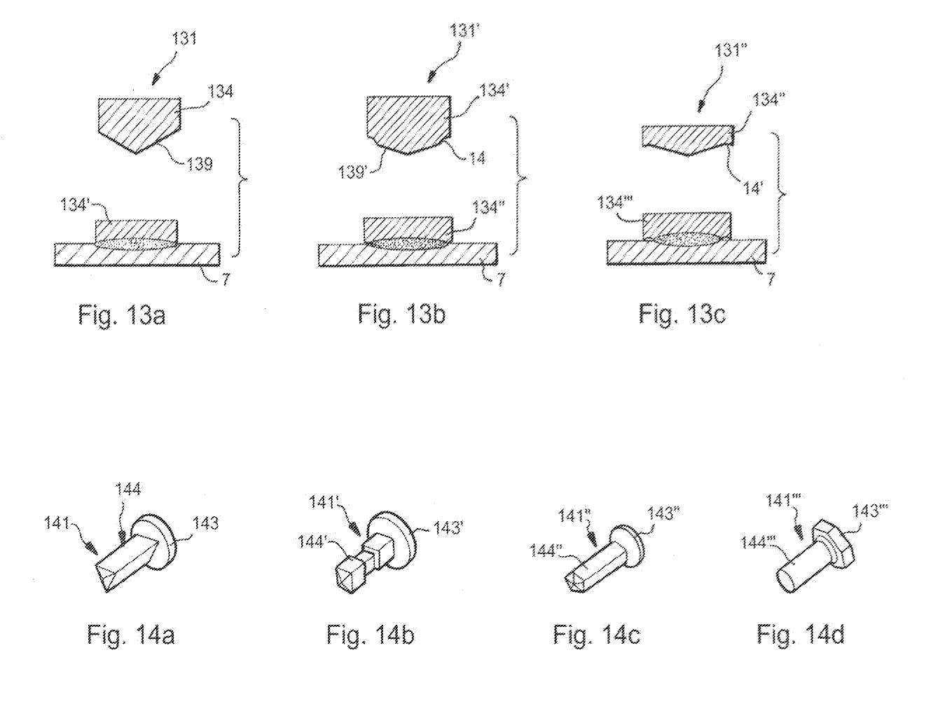

FIGS. 13a, b and c show differently shaped end faces 139, 139′ of the shank 134, 134′, 134″ of the weld rivet 131, 131′, 131″; a conical end face 139 as shown in FIG. 13a is particularly suitable for resistance or stud welding, while an end face 139′ as shown in FIG. 13b can form a chamfer 14 on the end face 139′ for a subsequent bead chamber. Such a bead chamber can alternatively be produced by a cavity 14′ as shown in FIG. 13c by way of example.

According to FIGS. 14a to 14d, the weld rivet 141, 141′, 141″ has a polygonal cross-section in its shank region or its head region, which secures the base component 7 against rotation relative to the component 6.

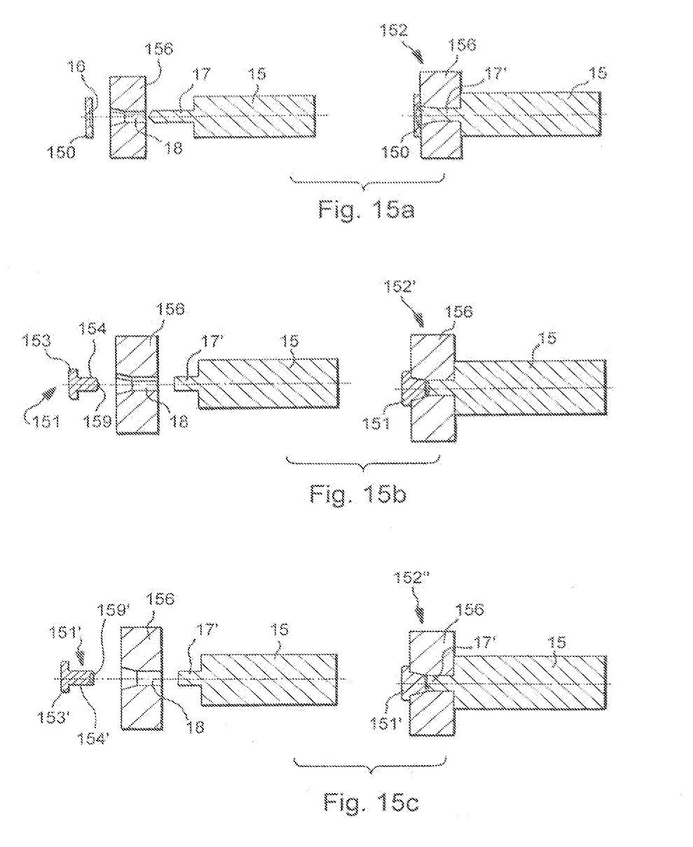

FIGS. 15a to 15c each shows a weld rivet joint 152, 152′, 152″ between one or more components 156 and a base component 7, wherein the component 156 also has a hole 18. The base component 7 of this embodiment is an axial extension 17, 17′ of a shaft 15, which engages the hole 18. The component 156 may accordingly be a rotor or a turbine wheel. This type of mounting may, for example, be considered for attaching a turbine wheel made of titanium aluminium to a shaft 15 made of steel or Inconel®. To solve such mounting problems, the weld rivet 150, 151, 151′ is made of a nickel-based steel alloy, while the shaft 15 is made of steel. The weld rivet 150 according to FIG. 15a may be restricted to a rivet head having a bead chamber 16 facing an end face of the axial extension 17 of the shaft 15. In FIGS. 15a to 15c, the hole 18 has a conical section, which provides for a particularly high joining force of the weld rivet joint 152, 152′ 152″.

The weld rivet shown in FIG. 15b is a solid rivet, and its end face 159 is welded to a corresponding end face of the axial extension 17′. This is followed by the upsetting of the weld rivet joint 152′ in the usual way. In contrast, the weld rivet 151′ shown in FIG. 15c is at least partially designed as a tubular rivet and therefore has an annular end face 159′ which is welded to the corresponding end face of the axial extension 17′. In general, the point in the interior of the component 156, for example in the interior of the turbine wheel, where the weld rivet 151′ is to be joined to the shaft 15 should be selected such that the weld rivet joint 152″ can be produced cost-effectively and is thermally stable in operation.

In general, it is possible to replace conventional joints such as threaded connections by the weld rivet joint 2 according to the invention, which offers major advantages in mechanical engineering and vehicle production, in particular in engine and body production.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A weld rivet joint between one or more components and a base component, wherein the one or more components have a hole through which a weld rivet having a head projects with its shank, wherein the shank is welded to a surface of the base component by its end face and is plastically deformed, wherein the base component has a cavity that accommodates at least the end region and parts of the shank of the weld rivet.

2. The weld rivet joint according to claim 1, wherein the cavity has a conical shape.

3. A weld rivet joint between one or more components and a base component, wherein the one or more components have a hole through which a weld rivet projects with its shank, the shank is welded to a surface of the base component by its end face and is plastically deformed,
wherein the weld rivet head is recessable into the one or more components, and
wherein the hole in the one or more components is arranged such that a the head of the weld rivet is recessed on completion of the weld rivet joint.

4. The weld rivet joint according to claim 3, wherein the hole is at least partially conical.

5. A weld rivet joint between one or more components and a base component, wherein the one or more components have a hole through which a weld rivet projects with its shank, the shank is welded to a surface of the base component by its end face and is plastically deformed,
wherein the weld rivet shank is longer than a diameter of the weld rivet head, and has a continuous annular recess in its shank region.

6. The weld rivet joint according to claim 5, wherein the end face of the shank is conical.

7. The weld rivet joint according to claim 6, wherein the weld rivet is a tubular rivet and has a blind hole which is open either towards the end face of the shank or towards the head.

8. The weld rivet joint according to claim 7, wherein the shank of the weld rivet has a tubular body.

9. The weld rivet joint according to claim 8, wherein a stud bolt is provided on a side of the head of the weld rivet which is remote from the shank.
